(19) United States
(12) Patent Application Publication
(10) Pub. No.: US 2004/0080517 A1
(43) Pub. Date: Apr. 29, 2004

(54) Driving method and apparatus of plasma display panel

(75) Inventors: Byung Soo Song, Kyungki-do (KR); Dae Jin Myoung, Kyungki-do (KR)

Correspondence Address: FLESHNER & KIM, LLP, P.O. BOX 221200, CHANTILLY, VA, 20153, US

(73) Assignee: LG Electronics Inc.

(21) Appl. No.: 10/671,657

(22) Filed: Sep. 29, 2003

(30) Foreign Application Priority Data
Oct. 2, 2002 (KR) 2002/60040
Mar. 4, 2003 (KR) 2003/13369
Mar. 4, 2003 (KR) 2003/13371

(51) Int. Cl. G09G 3/36

(52) U.S. Cl. 345/596; 345/89

(57) ABSTRACT

Disclosed is a driving method and apparatus of a PDP to decrease the false contour. In the driving method of the present invention, a false contour generation region is detected from a video data. After that, a motion information is extracted using the detected false contour generation region. A compensation value reflecting the extracted motion information is added or subtracted to or from a gray scale level that has generated the false contour, thereby efficiently reducing the false contour.

### BACKGROUND OF THE INVENTION

1. Field of the Invention

The present invention relates to a plasma display panel (PDP), and more particularly, to a driving method and apparatus of a PDP capable of reducing the false contour.

2. Description of the Related Art

As an information processing system develops and is widely supplied, a displaying device is of more importance as a visual information transmission means. A cathode ray tube (CRT) occupying a site as a main display device has disadvantages of a large size, a high voltage operation and display distortion, etc. In recent years, a flat display device such as a liquid crystal display (LCD), a field emission display (FED), a plasma display panel (PDP), etc. capable of overcoming the above disadvantages has been developed.

Among them, the PDP is an apparatus for displaying an image by exciting phosphor to emit light by a vacuum ultraviolet generated at the time of discharge of an inert mixture gas. The PDP has an advantage in that a thin film and a large size are not only easily accomplished, but also a structure is simplified so that its manufacture is easy and also a luminance and an emission efficiency is higher in comparison with other flat display devices. Specifically, an alternate current surface discharge PDP has an advantage of a low voltage operation and a long life due to the fact that a wall charge is charged on its surface at the time of discharge, and its electrodes are protected from sputtering generated by the discharge.

FIG. 1 illustrates a conventional three-electrodes alternate current surface discharge PDP.

Referring to FIG. 1, the alternate current surface discharge PDP includes a front glass substrate 1 having a front electrode 9 formed, and a rear glass substrate 2 having an address electrode 4 formed. The front glass substrate 1 and the rear glass substrate 2 have a barrier rib 3 interposed therebetween and are at a distance and in parallel with each other. Into a discharge space provided by the front glass substrate 1, the rear glass substrate 2 and the barrier rib 3 is injected a mixture gas of Ne+Xe, He+Xe, He+Ne+Xe, etc.

The front electrode 9 is provided in one plasma discharge cell, two by one pair. Each of the front electrodes 9 includes a wide transparent electrode and a narrow bus electrode connected to a one-sided edge of the transparent electrode. One of the paired front electrodes performs the discharge opposing to and together with the address electrode in response to a scan pulse supplied for an addressing period and then is used as a scan electrode for generating surface discharge with an adjacent front electrode in response to a sustain pulse supplied for a sustain period, and the other is paired with the scan electrode to be used as the sustain electrode for which the same sustain pulse is supplied commonly to the scan electrode.

On the front glass substrate 1 having the front electrode 9 formed are layered a front dielectric layer 7 and a protective layer 8. The front dielectric layer 7 limits a discharge current at the time of plasma discharge, and simultaneously stores the wall charge therein. The protective layer 8 is generally formed of oxide magnesium (MgO), and it prevents damage of the front dielectric layer caused by the sputtering generated at the time of the plasma discharge and increases the emission efficiency of a secondary electron.

On the rear glass substrate 2 is formed a rear dielectric layer 6 to cover an address electrode 4. The rear dielectric layer 6 protects the address electrode 4. On the rear dielectric layer 6 is formed the barrier rib 3 for partitioning the discharge space. On surfaces of the rear dielectric layer 6 and the barrier rib 3 are coated the phosphor 5 for being excited by the vacuum ultraviolet to generate a visible light of red (R), green (G) and blue (B).

Generally, the PDP is time-division-driven in the so-called address and display separated (ADS) driving method in which separation is made into an address period for selecting a pixel so as to display a gray scale of the image and a sustain period for generating the display discharge from the selected pixel. That is, one frame period is divided into several sub-fields in which the number (that is, times of sustain discharge) of the sustain pulse is differently set depending on a brightness weighting value, and each of the sub-fields is divided into a reset period, the address period and the sustain period. For example, in case it is intended to display the image with 256 gray scales, the frame period (16.67 ms) corresponding to 1/60 second is, as shown in FIG. 2, divided into eight sub-fields (SF1 to SF8). Additionally, as mentioned above, eight sub-fields are respectively divided into the reset period, the address period and the sustain period. At this time, the reset period and the address period are identical every sub-field, whereas the sustain period and the number of the sustain pulse allocated to the sustain period are increased in a proportion of 2ⁿ (n=0,1,2,3,4,5,6,7) in each of the sub-fields.

Accordingly, the number of the sustain pulses allocated to each of the sub-fields is mixed to thereby display a predetermined gray scale. For example, in order to display a gray scale of 64, the discharge is accomplished as many as the number of the sustain pulses created by switching-ON the sub-fields (SF1, SF2, SF3, SF4, SF5 and SF6) to respectively accumulate the brightness weighting values 2⁰, 2¹, 2², 2³, 2⁴ and 2⁵.

However, if the above ADS driving method is employed for displaying a mobile image, contours unpleasant to the eye appear around a mobile object to thereby deteriorate a display quality. This is called “false contour”. This false contour is caused by a difference of a light-emission center in a time axis. Herein, the light-emission center represents a time-viewed light center of the sub-fields switched-ON (that is, selected by the address period) within one frame. For example, in order to display a gray scale of 31 as shown in FIG. 2, the sub-fields (SF1, SF2, SF3, SF4 and SF5) are switched-ON so that the brightness weighting values 2⁰, 2¹, 2², 2³ and 2⁴ are accumulated, whereas in order to display a gray scale of 32, only the sub-field (SF6) is switched-ON so that only the brightness weighting value 2⁵ can be used for displaying the a gray-scale. At this time, in order to display the gray scale of 31, the discharge is performed for a long time as much as the sub-fields (SF1, SF2, SF3, SF4 and SF5), but in order to display the gray scale of 32, the discharge is performed only for a short time as much as the sub-field (SF5). That is, the gray scale of 31 and the gray scale of 32 have a difference by one gray scale, but the light-emission centers of the gray scale of 31 and the gray scale of 32 have a considerable difference generated. That is, as shown in FIG. 2, the light-emission center at the time of displaying the gray scale of 31 is positioned after a middle of one frame, whereas the light-emission center at the time of displaying the gray scale of 32 is positioned at an initial of one frame so that each of the light-emission centers of the gray scale of 31 and the gray scale of 32 is positioned with a considerable time difference.

As a result, the false contour is generated when the light-emission center between adjacent gray scales is rapidly varied in the time axis of the frame when the mobile image is displayed.

For example, as shown in FIG. 3, if a gray scale of 127 and a gray scale of 128 are moved to the right side, when an observer follows an object moving along a locus (A), it acknowledges the brightness with the gray scale 127, and when the observer follows the object moving along a locus (B), the observer acknowledges the brightness of the gray scale of 128.

However, if the object is followed along the locus (B) positioned on a boundary of the locus (A) and a locus (C), the observer acknowledges the most light brightness with a gray scale of 255 to which the gray scale of 127 and the gray scale of 128 are accumulated.

Until now, many methods have been proposed for reducing the above false contour. That is, a method for changing a sequence of the sub-field, a method for partitioning a most significant bit, a method for multiplexing a weighting value of the sub-field, a method for inserting an equalizing pulse into a driving pulse, etc.

However, the above conventional techniques are effective in reducing the false contour to some degree, but are not enough in more positively reducing the false contour.

### SUMMARY OF THE INVENTION

Accordingly, the present invention is directed to a driving method and apparatus of a PDP that substantially obviates one or more problems due to limitations and disadvantages of the related art.

It is an object of the present invention to provide a driving method and apparatus of a PDP capable of reducing the false contour by using a motion degree of a moving picture in a false contour generation region.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, there is provided a driving method of a PDP. The driving method includes the steps of: detecting a false contour generation region from a video data; and performing a selective dithering to the detected false contour generation region.

In an aspect of the invention, there is a driving method of a PDP. The driving method includes the steps of: respectively detecting false contour generation regions from video data of a previous frame period and a current frame period; extracting a motion information from the video data of the previous frame period and the current frame period including the detected respective false contour generation regions; and compensating the false contour by using the extracted motion information.

In another aspect of the present invention, there is provided a driving method of a PDP, comprising the steps of: respectively detecting a false contour generation regions from video data of a previous frame period and a current frame period; first compensating the false contour in the respectively detected false contour generation regions; when there exists a false contour generation region, which is not overcome by the first compensation of the false contour, extracting a motion information from the video data of the previous frame period and the current frame period; and secondly compensating the false contour by using the extracted motion information.

In a further aspect of the present invention, there is provided a driving apparatus of a PDP. The driving apparatus includes: means for respectively detecting a false contour generation regions from video data of a previous frame period and a current frame period; means for extracting a motion information from the video data of the previous frame period and the current frame period including the detected respective false contour generation regions; and means for compensating the false contour by using the extracted motion information.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 illustrates a conventional three-electrode alternate current surface discharge PDP;

FIG. 2 illustrates a sub-field pattern in which one frame period is divided into 8 sub-fields;

FIG. 3 exemplarily illustrates that a false contour is generated in a moving picture;

FIG. 4 is a block diagram schematically showing a driving apparatus of a plasma display panel according to a first preferred embodiment of the present invention;

FIG. 5 is a detailed view of the false contour processing part of FIG. 4;

FIG. 6 illustrates a gray scale, which generates a false contour according to a first embodiment of the present invention;

FIG. 7 illustrates a distribution of a false contour generation region according to a first embodiment of the present invention;

FIG. 8 illustrates a motion of a false contour generation region according to a first embodiment of the present invention;

FIG. 9 illustrates a motion of a false contour generation region through a window setting according to a first embodiment of the present invention;

FIG. 10 illustrates data to which a compensation value is allotted according to a first embodiment of the present invention;

FIG. 11 is a block diagram schematically showing a driving apparatus of a plasma display panel according to a second preferred embodiment of the present invention;

FIGS. 12A and 12B exemplarily illustrate false contour generation regions removed by a homogeneous filter according to a second embodiment of the present invention;

FIG. 13 is a block diagram schematically showing a driving apparatus of a plasma display panel according to a third preferred embodiment of the present invention;

FIG. 14 exemplarily illustrates a data conversion by a selective dithering processing according to a third embodiment of the present invention; and

FIG. 15 is a block diagram schematically showing a driving apparatus of a plasma display panel according to a fourth preferred embodiment of the present invention.

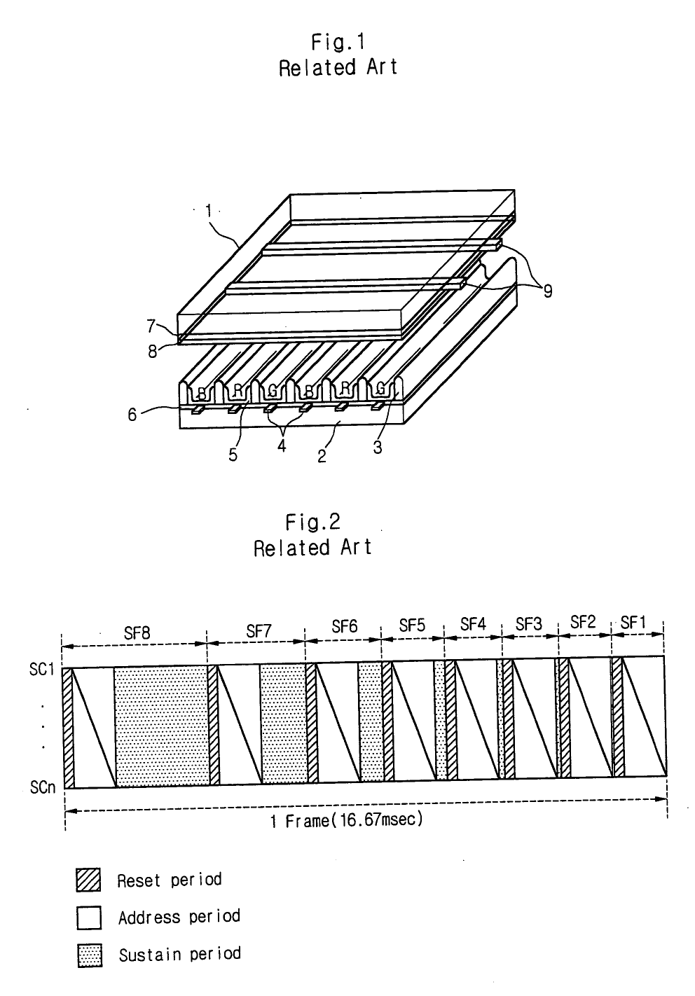

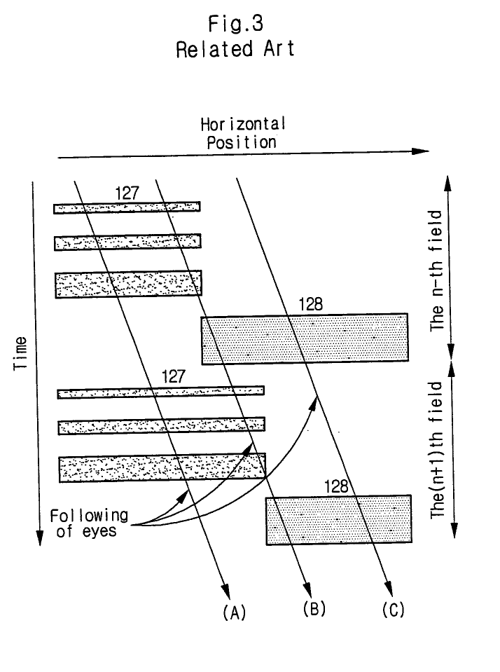

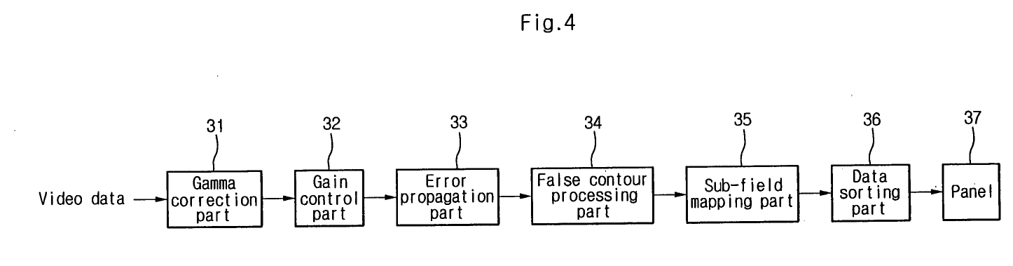

### DETAILED DESCRIPTION OF THE INVENTION

Reference will now be made in detail to the preferred embodiments of the present invention, examples of which are illustrated in the accompanying drawings.

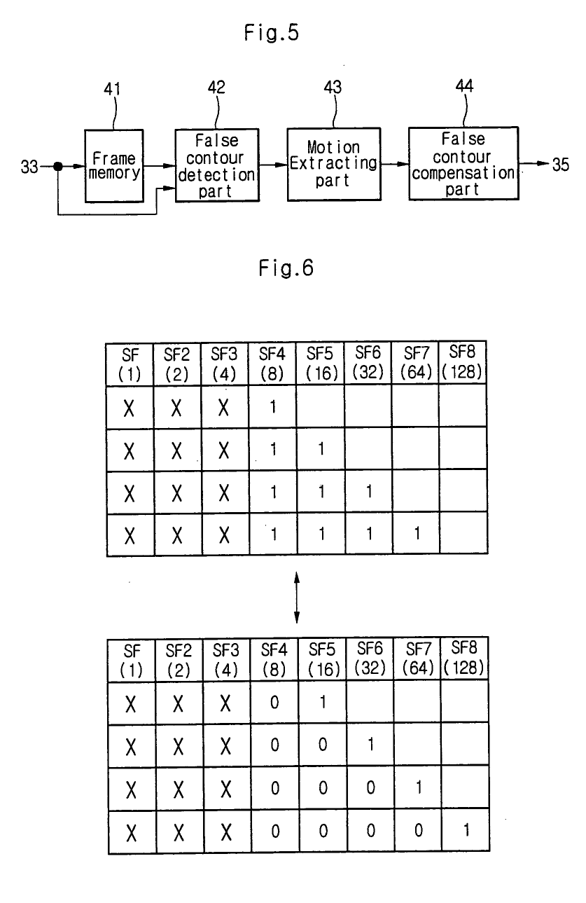

FIG. 4 is a block diagram schematically showing a driving apparatus of a plasma display panel according to a first preferred embodiment of the present invention, and FIG. 5 is a detailed view of the false contour processing part of FIG. 4.

Referring to FIGS. 4 and 5, a driving apparatus of a plasma display panel includes a gamma correction part 31, a gain control part 32, an error propagation part 33, a false contour processing part 34, a sub-field mapping part 35 and a data sorting part 36.

The gamma correction part 31 performs reverse gamma correction based on video data and transforms the brightness linearly depending on the gray scale level of the video data.

The gain control part 32 amplifies the video data transformed linearly by the gamma correction part 31 by effective gain. Here, the effective gain can be determined according to the average picture level (APL) value calculated from an APL part.

The error propagation part 33 propagates error components of the cell generated from the video data outputted from the gain control part 32 to adjacent cells, so that the brightness can be adjusted finely. The error propagation part 33 may be positioned between the gain control part 32 and the false contour processing part 34 or between the false contour processing part 34 and the sub-field mapping part 35.

The false contour processing part 34 compensates the gray scale level of the pixel generating the false contour by using compensation value set according to motion information extracted from the video data outputted from the error propagation part 33. Here, the equalizing pulse can be used as the compensation value.

The sub-field mapping part 35 is provided with a sub-field pattern in which brightness weighting value is allotted to each sub-field in advance. Accordingly, the sub-field mapping part 35 maps the video data outputted from the false contour processing part 34 on a preset sub-field pattern.

The data sorting part 36 transforms video data outputted from the sub-field mapping part 35 to be adapted to a resolution format of the PDP, and supplies the transformed video data to a data driving IC (not shown) of the panel 37. The data driving IC supplies the video data outputted from the data sorting part 36 to a plurality of data lines formed in the PDP.

The false contour processing part 34 extracts motion information from the video data outputted from the error propagation part 33, sets a proper compensation value according to the extracted motion information, and compensates false contour region generated from the video data by using the set compensation value. The aforementioned false contour processing part 34 is a main technical characteristic to be realized in the present invention, and will be described in more detail with reference to FIG. 5.

The false contour processing part 34 includes a frame memory 41, a false contour detection part 42, a motion extracting part 43 and a false contour compensation part 44.

The frame memory 41 temporarily stores the video data outputted from the error propagation part 33 such that the video data is delayed for one frame period. Concurrently with the above operation, video data is directly inputted into the false contour detection part 42 not via the frame memory 41. Accordingly, into the false contour detection part 42, the video data of a current frame period that is not via the frame memory 41 and the video data of a previous frame period that is via the frame memory 41 are concurrently inputted.

The false contour detection part 42 receives the video data of the previous and current frame periods at the same time, and determines whether or not there exists false contour generation region based on each video data. If false contour generation region exists in each video data, the false contour detection part 42 detects a corresponding region. For instance, as shown in FIG. 6, in a driving method in which gray scale is made by a combination of 8 sub-fields, gray scale may be generated when it is one among 16, 32, 64 and 128. Thus, the gray scale generating a false contour has a bit inversion transformed by a large degree compared with a gray scale lower by 1 gray scale level than the gray scale generating the false contour. As one example, a gray scale of 15 is constructed by a bit string of 11110000, whereas a gray scale of 16 is constructed by a bit string of 00001000. Accordingly, if the gray scale is increased from the gray scale of 15 to the gray scale of 16 by gray scale of 1, 11110 is bit-inverted into 00001, i.e., only five bits are inverted. At this time, ‘1’ located at the fifth site of 00001 indicates the most significant bit (MSB) of the gray scale of 16. When only the MSB becomes 1 and the bits below the MSB become 1 or 0, a corresponding gray scale becomes a gray scale capable of generating the false contour. Reviewing the MSB of gray scales capable of generating false contour, in case of a gray scale of 32, only the MSB of 6^{th} site becomes 1, in case of a gray scale of 64, only the MSB of 7^{th} site becomes 1, and in case of a gray scale of 128, only the MSB of 8^{th} site becomes 1. Thus, when an object of a moving picture is moved on a screen, the gray scale generating the false contour is recognized as a gray scale lower or higher than corresponding gray scale according to a viewing direction of an observer, thereby finally generating the false contour. Accordingly, such a false contour should be suppressed necessarily and at maximum.

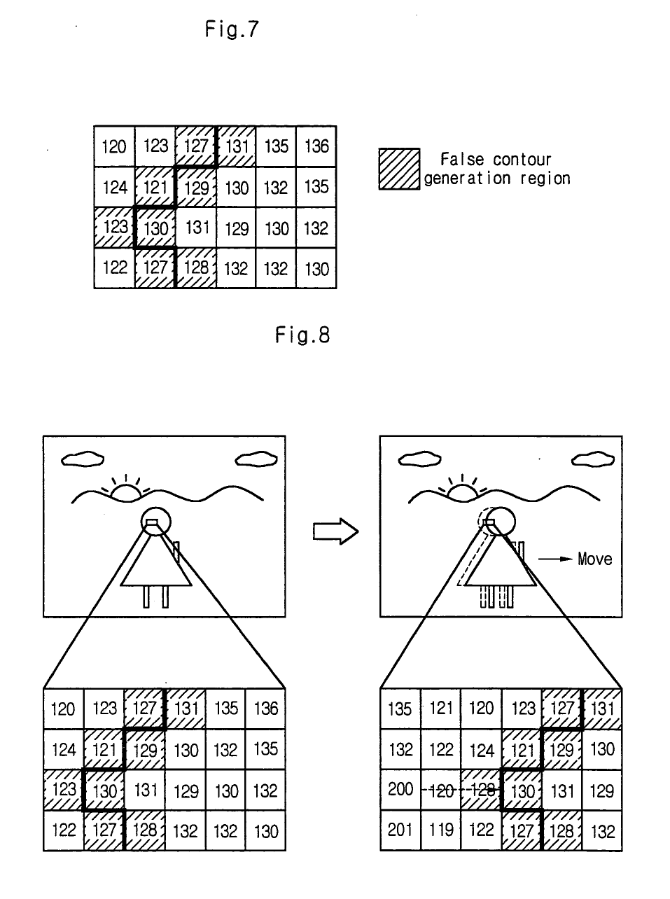

The false contour detection part 42 detects the false contour generation region such that a pixel corresponding to a gray scale generating the false contour and pixels corresponding to adjacent gray scales to the gray scale are included. For instance, as shown in FIG. 7, the false contour generation regions can be detected between gray scale of 127 and gray scale of 131, between gray scale of 127 and gray scale of 129, between gray scale of 121 and gray scale of 129, between gray scale of 121 and gray scale of 130, between gray scale of 123 and gray scale of 130, between gray scale of 130 and gray scale of 127, and between gray scale of 127 and gray scale of 128, respectively.

These false contour generation regions are detected with respect to both the video data of the previous frame period and the video data of the current frame period.

The motion extracting part 43 compares the video data of the previous frame period with the video data of the current frame period to extract whether or not there exists a motion of the false contour generation region. At this time, at the video data of the previous frame period and the video data of the current frame period, their respective false contour generation regions exist respectively.

Specifically, the motion extracting part 43 matches the video data of the previous frame period with the video data of the current frame period and then compares the false contour generation regions of the respective video data with each other to extract motion information. The motion information may include gray scale size, direction, velocity value and the like.

In FIG. 8, left drawing indicates video data of previous frame period and right drawing indicates video data of current frame period. At this time, in the video data of the previous frame period and the video data of the current frame period, there exist the false contour generation regions, respectively. Accordingly, if the video data of the previous frame period is matched with the video data of the current frame period to compare the false contour generation regions existing in the respective video data, it is known that the false contour generation region is moved toward right side.

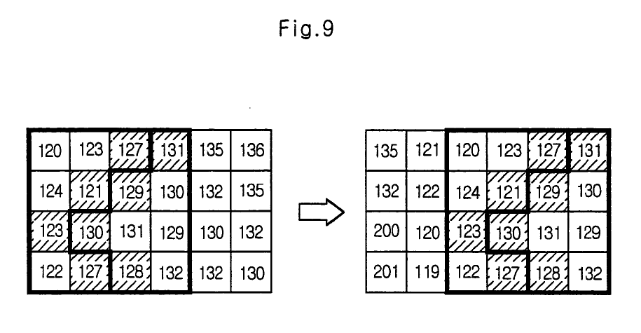

Such a motion information can be extracted more apparently as shown in FIG. 9 by setting a predetermined size of windows and matching the set windows. In other words, as shown in FIG. 9, 4 by 4 pixels are set as one window and motion, etc., of the set window is traced through a change in the gray scale of each of pixels included in the set window to thereby extract the motion information with more ease. In other words, the window set in FIG. 9 is moved toward the right side at a velocity of 2 pixel/frame. At this time, the gray scales of the false contour generation regions are distributed approximately between gray scale of 121 and gray scale of 131.

The motion information extracted from the motion extracting part 43 is inputted to the false contour compensation part 44 and used to compensate the false contour. In other words, the false contour compensation part 44 receives the motion information extracted from the motion extracting part 43 to compensate the false contour generation region by using a compensation value to which the motion information is reflected. The false contour compensation part 44 sets a proper compensation value (ex. number of equalizing pulses) according to the velocity value included in the motion information. The compensation value is varied in proportion to largeness and smallness of the velocity value. In other words, in case the velocity value is small, the compensation value is set small relatively whereas in case the velocity value is large, the compensation value is set large relatively.

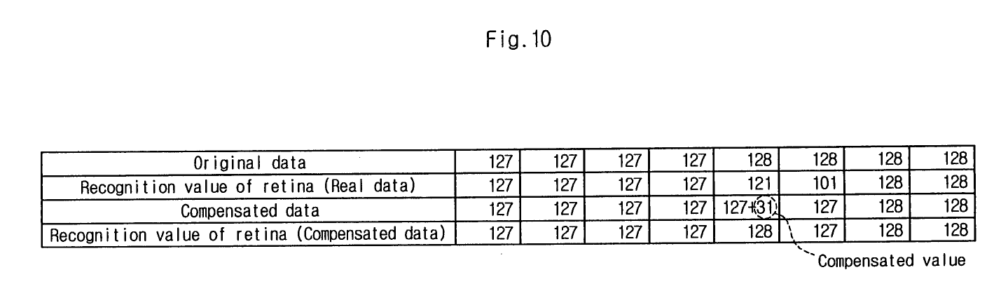

If the compensation value is set as aforementioned, the gray scale that has generated the false contour is added to or subtracted from according to the motion direction of the false contour generation region by using the set compensation value. For instance, as shown in FIG. 10, if the false contour generation region where gray scale of 127 and gray scale of 128 are adjacent to each other is moved toward the left side at a velocity of 3 pixel/frame, a dark image of false contour such as gray scale of 121 and gray scale of 101 appears between gray scale of 127 and gray scale of 128. In this case, the false contour compensation part sets a compensation value of ‘31’ according to the velocity of 3 pixel/frame and adds the set compensation value of ‘31’ to gray scale of 128 to suppress the false contour such that an image having the initial brightness is recovered.

If the false contour generation region where gray scale of 127 and gray scale of 128 are adjacent to each other is moved toward the right side at a velocity of 3 pixel/frame, a bright image of false contour appears between gray scale of 127 and gray scale of 128 unlike the aforementioned case. In this case, the compensation value is subtracted from gray scale of 127, brightness between gray scale of 127 and gray scale of 128 is lowered to recover an initial image.

As reviewed in the above, the driving apparatus of a PDP according to the first embodiment of the present invention extracts motion information simply by using the false contour generation region detected respectively from the video data of the previous frame period and the video data of the current frame period, sets a compensation value reflecting the extracted motion information and adds or subtracts the set compensation value to or from a gray scale generating the false contour, so that the false contour can be removed almost completely.

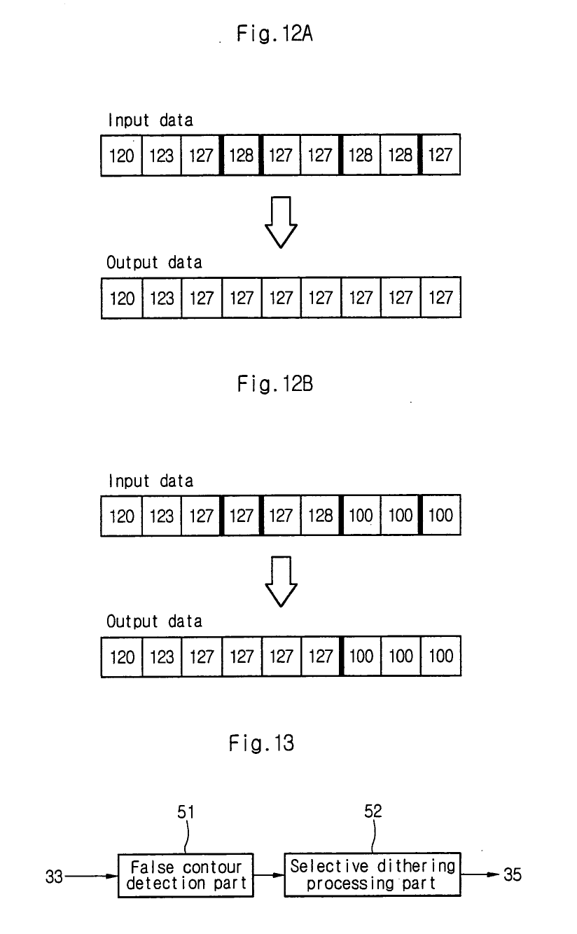

In the meanwhile, when the false contour generation region is detected from input video data, a plurality of false contour generation regions may be detected on a data string. In other words, as shown in FIG. 12A, four false contour generation regions are detected between 127 gray scale and 128 gray scale on the data string of input video data. Thus, if a plurality of false contour generation regions exist on a single data string, indistinct information may be extracted in extracting the motion information later, or it may take a much time to extract the motion information through the plurality of false contour generation regions. Accordingly, as shown in FIG. 12A, a false contour generation region where the false contour can be removed prior to extracting the motion information can be removed in advance.

At this time, it is desirable that an edge portion among the plurality of false contour generation regions, i.e., the false contour generation region existing between a moving article and a background is not removed. If the false contour generation region corresponding to the edge portion is removed, edge blur phenomenon that a corresponding edge is blurred may be caused. Accordingly, as shown in FIG. 12B, the false contour generation region where edge portion appears among the plurality of false contour generation regions may be left without a removal.

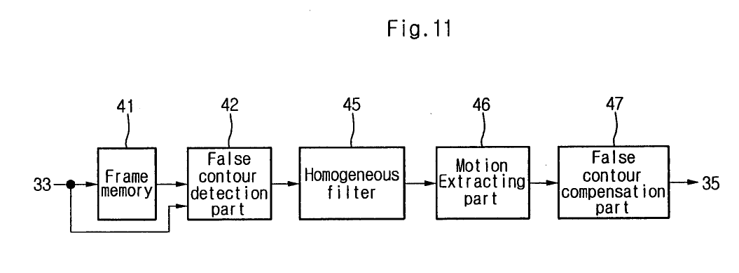

FIG. 11 is a block diagram schematically showing a driving apparatus of a plasma display panel according to a second preferred embodiment of the present invention.

Referring to FIG. 11, a driving apparatus of the present invention includes a frame memory 41, a false contour detection part 42, a homogeneous filter 45, a motion extracting part 46 and a false contour compensation part 47. Herein, since the frame memory 41 and the false contour detection part 42 are the same as those of the previous embodiment, their repeated description will be omitted.

The homogeneous filter 45 is connected between the false contour detection part 42 and the motion extracting part 46 substitutes or copies a gray scale value of a false contour generation location for a gray scale value adjacent to the false contour generation location pixel so as to remove a part or all of the false contour generation regions of the video data of the previous and the current frame periods detected from the false contour detection part 42 prior to extracting the motion information. In other words, the homogeneous filter 45 substitutes a gray scale generating the false contour with a gray scale adjacent thereto to replace the gray scale generating the false contour with the gray scale not generating the false contour and thereby decrease the number of the false contour generation regions. Thus, decreasing the number of the false contour generation regions is applied to all the video data of the current and previous frame periods. Also, the homogeneous filter 45, as shown in FIGS. 12A and 12B, can be applied when a plurality of false contour generation regions exist in a single data string. Accordingly, all the false contour generation regions except for the false contour generation region corresponding the edge portion is removed in each of the plurality of data strings included in video data.

The motion extracting part 46 extracts motion information from the video data of the previous and current frame periods in which false contour generation regions appearing on a data string from the homogeneous filter 45 are reduced. The false contour compensation part 47 sets a predetermined compensation value according to the extracted motion information and adds or subtracts a gray scale generating the false contour according to the set compensation value to recover the gray scale to an initial gray scale. Herein, since the motion extracting part 46 and the false contour compensation part 47 are the same as those of the previous embodiment, their repeated description will be omitted.

Accordingly, the driving apparatus of a PDP according to the second embodiment of the present invention, when a plurality of false contour generation regions exist in each data string of input video data, substitutes the plurality of false contour generation regions except for a gray scale corresponding to an edge portion with a gray scale of an adjacent pixel, thereby allowing more precise information to be extracted in extracting the motion information later and also shortening the extracting time of the motion information.

The false contour may be compensated simply by a different method than the above-described method.

FIG. 13 is a block diagram schematically showing a driving apparatus of a plasma display panel according to a third preferred embodiment of the present invention.

Referring to FIG. 13, a driving apparatus according to a third embodiment of the present invention includes a false contour detection part 51 and a selective dithering part 52.

Unlike those of the previous embodiments, the false contour detection part 51 detects false contour generation region of only the video data of the current frame period inputted in real time. In other words, the false contour detection part 51 searches the gray scale (ex. 8, 16, 32, 64, 128) that has generated the false contour from the video data of the current frame period and then detects a pixel corresponding to the searched gray scale and a pixel corresponding to a gray scale adjacent thereto as a single false contour generation region.

The selective dithering processing part 52 performs a selective dithering of only a false contour generation region detected from the false contour detection part 51 and disperses the locations of the false contour generation regions to be different with each other.

Accordingly, an observer deeply feels the false contour if the false contour generation region appears at the same location every frame but almost never feels the false contour if the false contour generation regions are dispersed different from each other every frame.

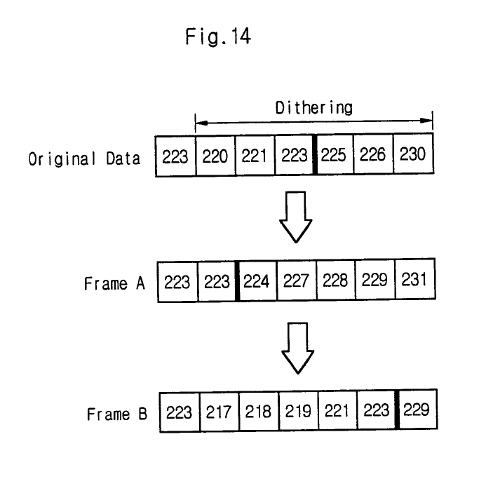

FIG. 14 exemplarily illustrates a data conversion by a selective dithering processing according to a third embodiment of the present invention.

If a false contour generation region is detected at gray scale of 223 and gray scale of 225 of an original data inputted into gray scale of 223, gray scale of 220, gray scale of 221, gray scale of 223, gray scale of 225, gray scale of 226 and gray scale of 230, the selective dithering processing part performs a dithering processing with respect to gray scales of pixels (ex. three pixels) included in a predetermined range of both sides of the false contour generation region. Accordingly, the gray scales included in the selective dithering processing are 220, 221, 223, 225, 226 and 230, so that the gray scales are converted into 223, 224, 227, 228, 229 and 231 in one frame period of frame A, and are converted into 217, 218, 219, 221, 223 and 229 in a next frame period of frame B. At this time, the conversion degree given to the selective dithering processing can be adjusted arbitrarily. However, if gray scales of each pixel in one frame period is increased as shown in FIG. 14, it is desirable that the gray scales are decreased by the increased value so that an average value of the gray scales corresponding during both frame periods becomes a corresponding gray scale value of the original data.

The aforementioned selective dithering processing part 52 can be applied to compensate the false contour by using the motion described in FIG. 5.

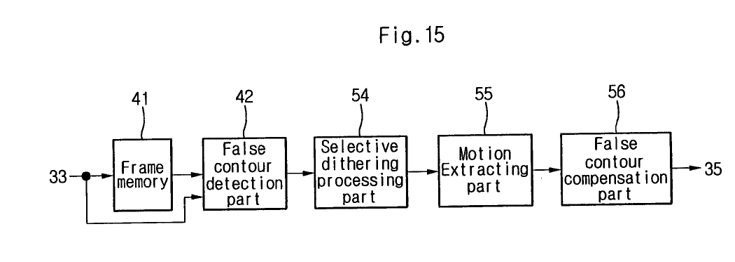

FIG. 15 is a block diagram schematically showing a driving apparatus of a plasma display panel according to a fourth preferred embodiment of the present invention.

Referring to FIG. 15, a plasma display panel of the present invention includes a frame memory 41, a false contour detection part 42, a selective dithering processing part 54, a motion extracting part 55 and a false contour compensation part 56. Here, since the respective parts are identical to those described above, operations or roles of the respective parts will be described in brief.

The frame memory 41 temporarily stores input video data such that the video data is delayed for one frame period.

The false contour detection part 42 receives video data of a previous frame period that is not via the frame memory 41 and video data of a current frame period that is via the frame memory 41, and determines whether or not there exists false contour generation region based on each video data.

The selective dithering processing part 54 performs the dithering to the video data of the previous and current frame periods to allow the position of the false contour generation region to be dispersed differently with each other.

The motion extracting part 55 matches the video data of the previous frame period with the video data of the current frame period, each of which is outputted from the selective dithering processing part 54, and extracts the motion information.

The false contour compensation part 56 sets a predetermined compensation value on the basis of the motion information extracted from the motion extracting part 55, and adds/subtracts the gray scale level, which has generated the false contour, using the set compensation value such that the false contour is suppressed at maximum.

Accordingly, the driving apparatus of the plasma display panel according to the fourth preferred embodiment of the present invention disperses the false contour by the selective dithering process such that the observer does not acknowledge the false contour, and then compensates the false contour using the motion information, thereby reducing the false contour more efficiently.

As described previously, a driving apparatus of a PDP according to the present invention extracts motion information simply by using the false contour generation region detected respectively from the video data of the previous frame period and the video data of the current frame period, obtains a compensation value reflecting the extracted motion information to compensate the false contour, so that the false contour is suppressed as much as possible and thus images having a pleasant and clean picture quality can be provided to viewers.

Also, the driving apparatus of the present invention, when a plurality of false contour generation regions exist in each data string of input video data, removes these false contour generation regions in advance, thereby shortening the extracting time of the motion information later to a large degree.

In addition, the driving apparatus disperses the locations of the false contour generation regions every frame by a selective dithering processing when false contour generation regions are detected without using the motion information such that viewers almost never feel the false contour.

Moreover, the driving apparatus of the present invention uses the selective dithering processing and the false contour compensation using the motion information together, thereby reducing the false contour more efficiently.

It will be apparent to those skilled in the art that various modifications and variations can be made in the present invention. Thus, it is intended that the present invention covers the modifications and variations of this invention provided they come within the scope of the appended claims and their equivalents.

What is claimed is:

1. A driving method of a plasma display panel (PDP), comprising the steps of:
detecting a false contour generation region from a video data; and
performing a selective dithering to the detected false contour generation region.

2. The driving method according to claim 1, wherein the selective dithering is performed to a gray scale of a pixel generating the false contour and gray scales of pixels included in a predetermined range.

3. The driving method according to claim 1, wherein the selective dithering allows the position of the false contour generation region to be dispersed differently with each other.

4. A driving method of a PDP, comprising the steps of:
respectively detecting false contour generation regions from video data of a previous frame period and a current frame period;
extracting a motion information from the video data of the previous frame period and the current frame period including the detected respective false contour generation regions; and
compensating the false contour by using the extracted motion information.

5. The driving method according to claim 4, wherein the video data of the previous frame period is stored such that the video data is delayed during one frame period by a frame memory.

6. The driving method according to claim 4, further comprising the step of performing a selective dithering to the false contour generation region detected from the video data of the current frame period.

7. The driving method according to claim 6, wherein the selective dithering is performed to a gray scale of a pixel generating the false contour and gray scales of pixels included in a predetermined range.

8. The driving method according to claim 4, further comprising the step of, prior to extracting the motion information, substituting a gray scale value of the false contour generation pixel for a gray scale value approaching a false contour generation pixel of each of the video data of the current frame period.

9. The method according to claim 4, wherein the false contour is generated when the gray scale having a combination of a plurality of sub-fields is any one among 16, 32, 64 and 128.

10. The method according to claim 4, wherein the extracting step comprises the steps of:
matching the video data of the previous frame period with the video data of the current frame period; and
extracting the motion information from a change of the movement of the false contour generation region included in the video data of the previous frame period and the current frame period.

11. The method according to claim 4, wherein the motion information comprises size, direction and velocity value of the gray scale.

12. The method according to claim 4, wherein the compensating step comprises the steps of:
setting a compensation value on the basis of the velocity value; and
adding or subtracting the compensation value to or from the gray scale which has generated the false contour depending on the direction.

13. The driving method according to claim 12, further comprising the step of setting the compensation value on the basis of the size of the gray scale.

14. The driving method according to claim 12, wherein the compensation value is varied in proportion to the velocity value.

15. A driving method of a PDP, comprising the steps of:
respectively detecting a false contour generation regions from video data of a previous frame period and a current frame period;
first compensating the false contour in the respectively detected false contour generation regions;
when there exists a false contour generation region, which is not overcome by the first compensation of the false contour, extracting a motion information from the video data of the previous frame period and the current frame period; and
secondly compensating the false contour by using the extracted motion information.

16. The driving method according to claim 15, wherein the first compensation of the false contour is performed by, when a plurality of false contour generation pixels exist in a data string of the video data of the previous frame period and the current frame period, substituting a gray scale value of the false contour generation pixel for a gray scale value approaching the false contour generation pixel.

17. The driving method according to claim 15, wherein the motion information comprises size, direction and velocity value of the gray scale level.

18. The driving method according to claim 15, wherein the second compensation of the false contour is performed by adding or subtracting the compensation value to or from the gray scale which has generated the false contour depending on the direction.

19. A driving apparatus of a PDP, comprising:
means for respectively detecting a false contour generation regions from video data of a previous frame period and a current frame period;
means for extracting a motion information from the video data of the previous frame period and the current frame period including the detected respective false contour generation regions; and
means for compensating the false contour by using the extracted motion information.

20. The apparatus according to claim 19, further comprising means for delaying the video data of the current frame period to output the delayed video data as the video data of the previous frame period.

21. The apparatus according to claim 19, further comprising means for performing a selective dithering to the false contour generation region detected from the video data of the current frame period.

22. The apparatus according to claim 4, wherein the motion information comprises size, direction and velocity value of the gray scale.

23. The apparatus according to claim 19, wherein the false contour is generated when the gray scale having a combination of a plurality of sub-fields is any one among 16, 32, 64 and 128.

24. The apparatus according to claim 19, wherein the extracting means extracts the motion information from a change of the movement of the false contour generation region through a matching of the video data of the previous frame period with the video data of the current frame period.

25. The apparatus according to claim 19, wherein the motion information comprises size, direction and velocity value of the gray scale.

26. The apparatus according to claim 19, wherein the compensating means, after setting the compensation value depending on the velocity value, adds or subtracts the set compensation value to or from a gray scale, which has generated the false contour.

27. The apparatus according to claim 19, wherein the compensating means sets the compensation values to be different depending on the size of the gray scale, which has generated the false contour.
